(19) United States
(12) Patent Application Publication
(10) Pub. No.: US 2025/0033652 A1
(43) Pub. Date: Jan. 30, 2025

(54) METHOD FOR TRANSMITTING PREDICTIVE INFORMATION TO A CONTROL UNIT OF A MOTOR VEHICLE AND/OR TO A SOFTWARE MODULE OF THE CONTROL UNIT

(71) Applicant: Volkswagen Aktiengesellschaft, Wolfsburg (DE)

(72) Inventors: Daniel Fries, Braunschweig (DE); Bruno Kerschgens, Braunschweig (DE)

(21) Appl. No.: 18/778,754

(22) Filed: Jul. 19, 2024

(30) Foreign Application Priority Data
Jul. 25, 2023 (DE) 102023207087.1

(51) Int. Cl. B60W 50/00; H04W 4/48

(52) U.S. Cl. CPC B60W 50/0097; H04W 4/48

(57) ABSTRACT

Technologies and techniques are disclosed for transmitting predictive information to a control unit of a motor vehicle and/or to a software module to determine an activation command for at least one function of the vehicle. The system forecasts a progression of a vehicle parameter for a predefined time interval. It determines at least one first extreme value of the forecasted progression within a first partial time interval starting at a present point in time, and at least one second extreme value within a second, longer partial time interval. The system then transmits the determined extreme values as predictive information to the control unit and/or software module.

### RELATED APPLICATIONS

The present application claims priority to German Patent Application No. 10 2023 207 087.1, to Fries, et al., filed on Jul. 25, 2023, the contents of which is incorporated by reference in its entirety herein.

### TECHNICAL FIELD

The present disclosure relates to technologies and techniques for transmitting predictive information to a control unit of a motor vehicle so as to determine, using a control unit, an activation command for at least one function of the motor vehicle by evaluating the transmitted predictive information. The present disclosure also relates to a motor vehicle for carrying out such a method.

### BACKGROUND

Motor vehicles can include an algorithm within their control unit that forecasts information, such as predicting the future progression of certain vehicle parameters. This forecast information is utilized for the intelligent activation of the vehicle's drive device, enabling energy-efficient operation. For instance, in a vehicle with electric motors on both the front and rear axles, the system may deactivate one of the motors temporarily to conserve energy. The secondary drive motor can be decoupled during low-load driving at constant speed and recoupled when an increased load is anticipated. This activation command is determined based on predictive information, such as forecasted wheel torque. By evaluating this information, the vehicle can intelligently activate functions, such as decoupling or coupling the secondary drive in a dual-motor vehicle.

US 2021/0316632 A1 describes a method for processing a predetermined computing task using a distributed, vehicle-based computing system. The task is divided into several data packets containing respective computing data for portions of the task.

CN 106713512 A details an efficient data transmission method capable of dynamically balancing a changing network bandwidth in the Internet of Things.

Within the vehicle, predictive information and activation commands are often determined in different modules or control units, necessitating internal transmission of the predictive information. This requires substantial transmission power since predictive information must be determined and transmitted for multiple vehicle parameters several times per second. Additionally, depending on the transmission type, aliasing can occur, where dynamic progressions cannot be accurately represented or determined due to an insufficient sampling rate.

### SUMMARY

Aspects of the present disclosure are directed to providing a solution for advantageously transmitting predictive information within a motor vehicle to a control unit and/or a software module for determining activation commands.

Aspects of the present disclosure are described in the features recited in the independent claims found below. Further aspects are described in the features recited in the dependent claims.

In some examples, a method is disclosed for transmitting predictive information to a control unit of a motor vehicle and/or to a software module of the control unit. This enables the control unit or the software module to determine an activation command for at least one function of the motor vehicle by evaluating the transmitted predictive information. The control unit may be a control module or control device in the motor vehicle, responsible for activating at least one component of the vehicle. The software module is a component or sub-unit of the control unit. The activated component could be a drive device or a related component. For example, coupling or decoupling a secondary drive can be the function when the vehicle has primary and secondary drives designed as electric motors assigned to respective wheel axles. The primary drive is arranged at the rear axle, while the secondary drive is at the front axle. In a low-load range, it may be useful to decouple the secondary drive, such as when driving at a constant speed in a predefined speed zone. The activation command may relate to either decoupling or coupling the secondary drive. To recouple the secondary drive in a timely manner, before it is needed, the activation command is determined based on predictive information. This allows anticipatory operation of the drive device. Additionally, the function could relate to start-stop control of an internal combustion engine when stationary, operation in recuperation mode, or another energy-saving function.

In some examples, a motor vehicle is disclosed that carries out the described method. The vehicle can include the control unit and possibly a further control unit and/or software module responsible for predicting progression, determining extreme values, and transmitting these values. The motor vehicle may be configured as a car, such as a passenger car, truck, passenger bus, or motorcycle.

The respective control unit is also part of the present disclosure. The control unit can include a data processing device or processor configured to carry out the disclosed method. The processor may comprise at least one microprocessor, microcontroller, field-programmable gate array (FPGA), or digital signal processor (DSP). Specifically, a central processing unit (CPU), graphical processing unit (GPU), or neural processing unit (NPU) can be used as a microprocessor. The processor device may also include program code designed to execute the disclosed method when run by the processor. This program code can be stored in a data memory of the processor device, which may be based on at least one circuit board or system on a chip (SoC).

The present disclosure also encompasses refinements of the motor vehicle including features described in connection with the exemplary embodiments of the method. These corresponding refinements are not repeated here.

Additionally, the present disclosure encompasses combinations of features of the described exemplary embodiments.

### BRIEF DESCRIPTION OF THE DRAWINGS

Examples of the examples and embodiments are described hereafter. In the drawings:

FIG. 1 shows a schematic representation of a motor vehicle comprising a control unit, according to some aspects of the present disclosure;

FIG. 2 shows a schematic representation of a signal flow graph of a method for transmitting predictive information to a control unit of a motor vehicle, according to some aspects of the present disclosure; and

FIG. 3 shows a schematic representation of two exemplary embodiments for a method according to FIG. 2, according to some aspects of the present disclosure.

### DETAILED DESCRIPTION

The examples described hereafter are preferred exemplary embodiments of the present disclosure. In these exemplary embodiments, the described components each represent individual features that are to be considered independently and each can refine the present disclosure independently or in combination with other features. These described exemplary embodiments can also be supplemented with additional features as described in the present disclosure.

In the figures, functionally equivalent elements are denoted by the same reference numerals.

In some examples, the method is carried out by a further control unit of the motor vehicle, which differs from the control unit for determining the activation command. Thus, a distinction can be made between a first and a second control unit. Alternatively or additionally, the method can be carried out by a further software module within the control unit of the motor vehicle. This module can be part of the control unit responsible for determining the activation command. In this case, the predictive information can be transmitted from the further software module to the software module of the control unit that determines the activation command. Preferably, the transmission of predictive information occurs within the motor vehicle. Information transmission within the vehicle between control units can be wired and/or wireless. Alternatively or additionally, information transmission can occur within the control unit if two different software modules or functions of a single control unit are involved.

The method involves forecasting a progression of a vehicle parameter for a predefined time interval. For example, a vehicle parameter, such as wheel torque, is predicted for a set duration in the future. This time interval can be 1, 2, or 3 seconds, or any other suitable interval. It begins at a present point in time and continues into the future. Known methods for forecasting vehicle parameters can be used. Additionally, parameters such as wheel speed, vehicle speed, acceleration, or other driving parameters can be forecast. The forecast includes multiple individual values that the vehicle parameter is expected to take on during the time interval. These values form a curve, referred to as the progression of the vehicle parameter. Interpolation methods can be used to connect the individual forecast values, creating the progression.

The method includes determining at least one first extreme value of the forecast progression within a first partial time interval, starting at the present point in time. For instance, a maximum value of the vehicle parameter can be identified as a first extreme value in the first partial time interval. This extreme value requires significantly less memory space compared to the entire progression and can be transmitted with less effort.

Additionally, at least one second extreme value of the forecast progression is determined within a second partial time interval, which is longer than the first. For example, the second partial time interval might be 1 second long. The first and second extreme values can be identical or different, depending on the forecast progression. Alternative partial time intervals are possible.

The respective determined extreme value includes a value of the vehicle parameter and time information indicating when this value was forecast. The extreme value can thus be referred to as extreme information describing the first or second extreme value.

The method involves transmitting the determined first and second extreme values as predictive information to the control unit and/or the software module. These extreme values represent the predictive information needed to determine the activation command. As a result, only the extreme values are provided rather than the entire forecast progression, reducing the volume of information to be transmitted while still providing necessary details for determining the activation command. The predictive information is thus advantageously transmitted within the motor vehicle to the control unit and/or the software module for determining activation commands.

According to one example, the control unit and/or the software module receive the first and second extreme values and check whether they fall within a predefined value range. This example is carried out by the control unit responsible for determining the activation command. The predefined value range can include an upper or lower limit, indicating when a certain function should be triggered. If at least one extreme value falls within the predefined range, an activation command is determined and executed to activate the vehicle function.

The activation command can be determined for a future point in time within the time interval, allowing for preparatory implementation. The determination and execution of the activation command can occur at different times.

Furthermore, according to another example, the activation command is only determined and executed when both the first and second extreme values fall within the predefined range and are not forecast for the same point in time. This ensures that vehicle parameters are consistently within the value range before activating the function, avoiding temporary or incorrect activations based on isolated extreme values.

An additional example provides that each extreme value describes a maximum or minimum of the forecast progression. Preferably, two extreme values (a maximum and a minimum) are determined per partial time interval. This allows for a detailed estimation of the progression of the vehicle parameter, improving the accuracy of the activation command determination.

Another example involves an activation command being determined and executed such that the function is not activated if both extreme values describe the maximum for the same point in time but describe minima outside the predefined range for different points in time. This prevents activation of the function when long-term activation conditions are not met.

In general, if neither the maximum nor the minimum is within the respective predefined range, the function according to the activation command is not activated, maintaining the current state, such as keeping the secondary drive decoupled. A reset criterion can be predefined, indicating when the function should not be activated based on the extreme values.

Various activation strategies can be predefined based on the extreme values to determine the corresponding activation command.

According to one example, the progression of the vehicle parameter is forecast by applying a forecasting criterion to sensor information detected by a sensor device of the motor vehicle. The sensor device may include sensors describing vehicle operation, such as gas pedal actuation, wheel speed, or steering angle, and surroundings sensors like cameras, radar, LIDAR, or ultrasonic sensors. Sensor information can describe both internal and external surroundings of the vehicle and can be used to determine vehicle position. The sensor device provides this information to the control unit or software module for forecasting the progression.

The forecasting criterion includes algorithms or rules that infer the progression of the vehicle parameter from sensor information. Multiple portions/pieces of sensor information from different devices can be combined to determine predictive information.

Furthermore, one example provides that a reliability value is determined for each extreme value and transmitted. The reliability value indicates the reliability of the forecast progression in the partial time interval, assessed as a value between 0 and 1 or 0% and 100%. This allows for different weightings of the transmitted extreme values during the activation command determination, considering the reliability of the forecast progression.

If, for example, the forecast for the second partial time interval is less reliable than for the first partial time interval, determined by a lower or higher corresponding reliability value, it may be predefined that only the first extreme value is considered during the determination of the activation command, excluding the second extreme value. In this example, only the most reliable extreme value is considered for determining the activation command, based on the highest or lowest reliability value of the transmitted values. Alternatively or additionally, a reliability limit value or a reliability value range can be predefined, where only the extreme value with a reliability value above or below the limit (depending on the definition) or within the range is considered. This allows for an initial assessment of the appropriateness of controlling the vehicle function based on the predictive information. If the reliability values are insufficient, other methods for determining the activation command that do not require predictive information may be used, or the function may be paused.

In an additional example, the respective reliability value is determined by comparison. Forecasted vehicle parameters, temporarily stored, are selected for a past time interval and compared to vehicle parameters actually measured during this interval. This evaluation, for example, for the last 5 seconds, assesses how reliably the vehicle parameter progression was forecast, given the actual progression measured. This retrospective assessment helps determine the accuracy and reliability of the forecast, assuming these will remain constant for a near-future time interval, typically within several seconds or minutes, up to a maximum of 5 minutes.

Alternatively or additionally, the reliability value can depend on the forecasting criterion. If the criterion is based on machine learning methods, such as an artificial neural network, the training quality of the forecasting criterion and the AI model training quality can be considered in providing the reliability value. The reliability value can thus be predefined based on the forecasting criterion used.

Alternatively or additionally, the reliability value can be determined by evaluating some or all pieces of sensor information. For instance, if lapses in sensor information detection occurred due to local issues, the reliability value can be computed based on this data. Sporadic availability of sensor information can reduce the reliability value compared to consistently available sensor data.

Alternatively or additionally, the reliability value can depend on the sensor device's quality. For example, the number of visible satellites in GNSS data positioning can affect the reliability value. The reliability value is computed based on the quality of the sensor device and the detection of information, which can be location- and time-dependent.

Numerous options exist for assessing quality and determining the reliability value to ensure precise determination or predefined reliability.

In another example, the function of the motor vehicle relates to the drive device. The activation command defines an operating strategy for the drive device, preferably involving drive train control. The vehicle parameter can relate to vehicle speed or target torque of the steering system for the next few seconds. Using the activation command, efficiency and comfort advantages for the vehicle's drive can be achieved.

For application cases or situations not explicitly described here, it may be provided that an error message and/or a request for user feedback is output, or a standard setting and/or a predetermined initial state is set.

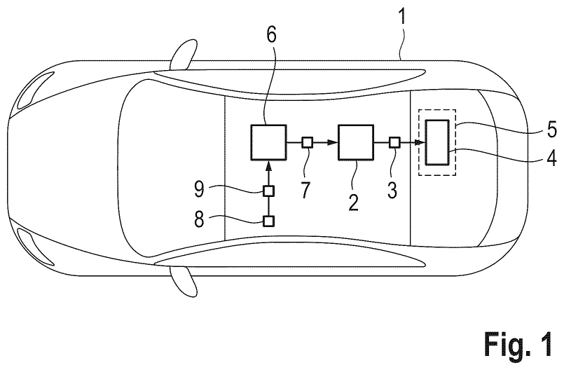

FIG. 1 shows a motor vehicle 1 with a control unit 2. The control unit 2 is configured to determine an activation command 3 for at least one function 4 of the motor vehicle 1. The activation command 3 relates to activating, deactivating, or pausing the function 4. The function 4 preferably relates to a drive device 5 of the motor vehicle 1, with the activation command 3 defining an operating strategy for the drive device 5.

The motor vehicle 1 includes a further control unit 6, which can alternatively be a software module in the vehicle, such as within the control unit 2. The further control unit 6 is configured to determine and transmit predictive information 7 to the control unit 2. For this purpose, the further control unit 6 can evaluate at least one portion of sensor information 9 transmitted by a sensor device 8 of the motor vehicle 1. The sensor device 8 detects sensor information 9, such as speed, steering angle, wheel speed, gas pedal actuation value, or other driving-related parameters. Alternatively or additionally, sensor information 9 can include camera data, radar data, LIDAR data, or ultrasonic sensor data. The sensor device 8 can be any on-board sensor of the motor vehicle 1.

The transmission of sensor information 9, predictive information 7, and/or activation command 3 can occur via a wired communication link within the motor vehicle 1. Alternatively or additionally, the communication link can be designed to be at least partly wireless.

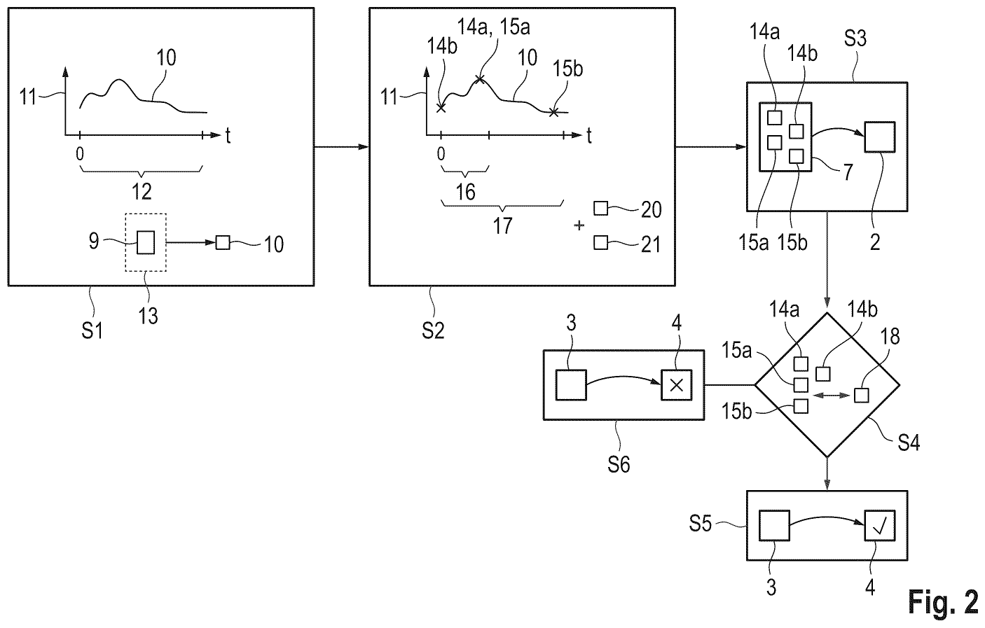

FIG. 2 shows method steps of a method for transmitting the predictive information 7 to the control unit 2 of the motor vehicle 1. In a method step S1, a progression 10 of a vehicle parameter 11 of the motor vehicle 1 is forecast for a predefined time interval 12. The progression 10 is determined, for example, by applying a forecasting criterion 13 to the at least one portion of sensor information 9. For example, the progression 10 of a wheel torque or another vehicle parameter 11 of the motor vehicle 1 is predicted. The predefined time interval 12 can be, for example, 2 or 3 seconds long, starting at a present point in time (t=0). An exemplary curve is outlined here as the progression 10, wherein the vehicle parameter 11 is plotted against the time t in the chart.

In a method step S2, at least one first extreme value of the forecast progression 10 is determined, which is in a first partial time interval 16 of the predefined time interval 12 beginning at a present point in time. Additionally, at least one second extreme value is determined, which is in a second partial time interval 17 of the predefined time interval 12 beginning at the present point in time. The second partial time interval 17 is longer than the first partial time interval 16. The first partial time interval 16 can be 0.5 seconds long, for example, while the second partial time interval 17 can be 1 second long. Here, a maximum 14a, 15a, as well as a minimum 14b, 15b per partial time interval 16, 17, respectively, are determined as extreme values. Here, the maxima 14a, 15a in the two partial time intervals 16, 17 coincide, for example, so that a joint maximum 14a, 15a is determined. The two minima 14b, 15b differ here, so that each minimum 14b, 15b is different from the respective other minimum 14b, 15b per partial time interval 16, 17. It may additionally be provided that a reliability value 20, 21 is determined for the respective extreme value, which describes the reliability of the forecast of the progression 10 in the respective partial time interval 16, 17.

[The respective reliability value 20, 21 can be determined by a comparison of vehicle parameters 11 forecast for a past time interval 12 to vehicle parameters 11 measured during this time interval 12 and/or can be dependent on the forecasting criterion 13 and/or can be determined by evaluating some and/or all of the portions of sensor information 9 and/or can depend on the sensor device 8.

In a method step S3, the determined at least one first extreme value and the determined at least one second extreme value are transmitted as the predictive information 7 to the control unit 2.

It may then be provided in a method step S4 that the control unit 2 receives the extreme values and checks whether these are within a predefined value range 18. A dedicated value range 18 can be predefined for the maxima 14a, 15a and the minima 14b, 15b. If one of the extreme values is in the predefined value range 18, an activation command 3 can be determined, according to which the function 4 of the motor vehicle 1 is activated. This occurs in method step S5. In the method step S5, the determined activation command 3 can additionally be executed, meaning that, for example, the function 4 of the motor vehicle 1 can be activated.

If it is determined in method step S4 that the extreme values are outside the predefined value range 18, an activation command 3 can be determined and executed in method step S6, according to which the function 4 is not activated. In this case, the function remains deactivated or paused, for example.

The method steps S1 to S3 are carried out by the further control unit 6. The method steps S4 to S6 are carried out by the control unit 2. Alternatively or additionally, the method steps S1 to S3 can be carried out by a further software module of the control unit 2, and the method steps S4 to S6 can be carried out by a software module of the control unit 2 for determining the activation command 3 (not outlined here).

It may be provided that the respective transmitted reliability value 20, 21 is taken into consideration during the determination of the activation command 3 in method step S5. Depending on how reliable the respective extreme value is, an adapted operating strategy can be selected for the drive device 5 by determining a corresponding activation command 3.

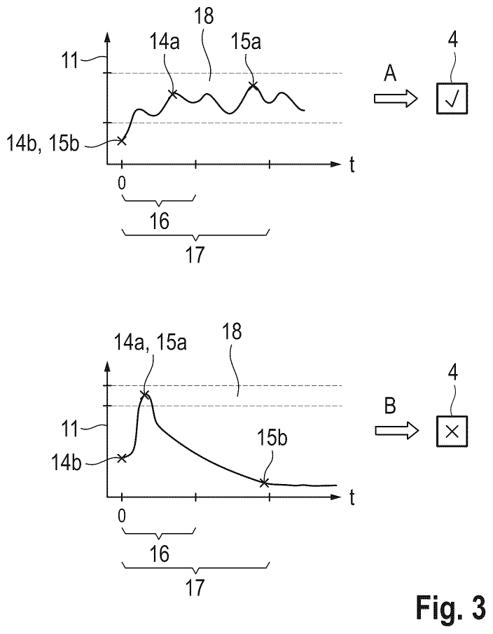

FIG. 3 outlines, as situation A, the case in which a dedicated maximum 14a, 15a is determined for each of the two partial time intervals 16, 17, so that it can be assumed that maxima 14a, 15a within the predefined value range 18 will repeatedly occur. It may be predefined that the function 4 of the motor vehicle 1 is only activated according to the activation command 3 when the at least one extreme value and the at least one second extreme value are within the predefined value range 18, and when these were not forecast for the same point in time.

Situation B outlines a case in which the two extreme values describe the maximum 14a, 15a for the same point in time but describe minima 14b, 15b for different points in time, with the minima being outside the predefined value range 18. Here, the activation command 3, according to which the function 4 is not activated, is determined and executed. Other or alternative operating strategies are possible.

Overall, the examples show a method for efficiently transmitting and processing/utilizing predictive information 7 in a motor vehicle 1. Instead of a continuous data stream of the predictive physical variable (progression 10) at various future points (t+x, t+y, t+n), only the necessary minimum or maximum values, and thus the respective extreme values, are transmitted from the continuous prediction results (progression 10) in the predefined prediction time periods (partial time intervals 16, 17) to the control unit 2. This reduces the required transmission bandwidth and computing capacity, and prevents aliasing of the predictive information 7.

By using and considering two differently long prediction time periods (partial time intervals 16, 17), simple and less intelligent hysteresis can be replaced with logics that take intelligent predictive data (predictive information 7) into consideration. This allows for functional logics based on predictive vehicle behavior, which more effectively account for vehicle behavior. For example, a hysteresis threshold does not need to be predefined as a limit value requiring a lower value for switching off than for switching on, since the intelligent controller based on extreme values does not need this.

The forecasting of the progression, the determination of the extreme values, and their transmission to the control unit 2 are carried out by a predictor or prediction module in the motor vehicle 1, referred to here as the further control unit 6. The receiving of the extreme values and the determination and execution of the activation command 3 are carried out by the control unit 2, which can alternatively be referred to as a control command module.

### LIST OF REFERENCE SIGNS

1 motor vehicle
2 control unit
3 activation command
4 function
5 drive device
6 further control unit
7 predictive information
8 sensor device
9 sensor information
10 progression
11 vehicle parameter
12 time interval
13 forecasting criterion
14a, 15a maxima
14b, 15b maxima
16 first partial time interval
17 second partial time interval
18 value range
20 reliability value
21 reliability value
S1 to S6 method steps
A, B situation
t time

1. A method for transmitting predictive information to a control unit of a motor vehicle and/or to a software module of the control unit to determine an activation command for at least one function of the motor vehicle by evaluating the transmitted predictive information, the method comprising:
forecasting a progression of a vehicle parameter of the motor vehicle for a predefined time interval;
determining at least one first extreme value of the forecasted progression within a first partial time interval of the predefined time interval starting at a present point in time;
determining at least one second extreme value of the forecasted progression within a second partial time interval of the predefined time interval starting at the present point in time, the second partial time interval being longer than the first partial time interval; and
transmitting the determined at least one first extreme value and the determined at least one second extreme value as the predictive information to the control unit and/or to the software module.

2. The method according to claim 1, wherein the control unit and/or the software module receive the at least one first extreme value and the at least one second extreme value and check whether at least one of the extreme values is within a predefined value range, and wherein an activation command according to which the function of the motor vehicle is activated is determined and executed if at least one of the extreme values is within the predefined value range.

3. The method according to claim 2, wherein the activation command according to which the function of the motor vehicle is activated is only determined and executed when the at least one first extreme value and the at least one second extreme value are within the predefined value range and were not forecast for the same point in time.

4. The method according to claim 1, wherein the respective at least one extreme value describes a maximum and/or a minimum of the progression.

5. The method according to claim 4, wherein an activation command according to which the function is not activated is determined and executed if both extreme values describe the maximum for the same point in time but describe minima that are outside the predefined value range for different points in time.

6. The method according to claim 1, wherein the progression of the vehicle parameter is forecast by applying a forecasting criterion to at least one portion of sensor information detected by a sensor device of the motor vehicle.

7. The method according to claim 1, wherein a reliability value, which describes a reliability of the forecast of the progression in the respective partial time interval, is determined for the respective extreme value and is transmitted, the control unit and/or the software module utilizing the determined reliability values during the determination of the activation command.

8. The method according to claim 7, wherein the respective reliability value is determined by a comparison of vehicle parameters forecast for a past time interval to vehicle parameters measured during this time interval.

9. The method according to claim 1, wherein the function of the motor vehicle relates to a drive device of the motor vehicle, and the activation command predefines an operating strategy for the drive device.

10. A motor vehicle comprising:
a control unit configured to determine an activation command for at least one function of the motor vehicle by evaluating transmitted predictive information;
a forecasting module configured to forecast a progression of a vehicle parameter of the motor vehicle for a predefined time interval;
a processing module configured to determine at least one first extreme value of the forecasted progression within a first partial time interval of the predefined time interval starting at a present point in time and to determine at least one second extreme value of the forecasted progression within a second partial time interval of the predefined time interval starting at the present point in time, the second partial time interval being longer than the first partial time interval; and
a communication module configured to transmit the determined at least one first extreme value and the determined at least one second extreme value as the predictive information to the control unit and/or to a software module.

11. The motor vehicle according to claim 10, wherein the control unit and/or the software module is configured to receive the at least one first extreme value and the at least one second extreme value and check whether at least one of the extreme values is within a predefined value range, and wherein an activation command according to which the function of the motor vehicle is activated is determined and executed if at least one of the extreme values is within the predefined value range.

12. The motor vehicle according to claim 11, wherein the activation command according to which the function of the motor vehicle is activated is only determined and executed when the at least one first extreme value and the at least one second extreme value are within the predefined value range and were not forecast for the same point in time.

13. The motor vehicle according to claim 10, wherein the respective at least one extreme value describes a maximum and/or a minimum of the progression.

14. The motor vehicle according to claim 13, wherein an activation command according to which the function is not activated is determined and executed if both extreme values describe the maximum for the same point in time but describe minima that are outside the predefined value range for different points in time.

15. The motor vehicle according to claim 10, wherein the progression of the vehicle parameter is forecast by applying a forecasting criterion to at least one portion of sensor information detected by a sensor device of the motor vehicle.

16. The motor vehicle according to claim 10, wherein a reliability value, which describes a reliability of the forecast of the progression in the respective partial time interval, is determined for the respective extreme value and is transmitted, the control unit and/or the software module utilizing the determined reliability values during the determination of the activation command.

17. The motor vehicle according to claim 16, wherein the respective reliability value is determined by a comparison of vehicle parameters forecast for a past time interval to vehicle parameters measured during this time interval.

18. The motor vehicle according to claim 10, wherein the function of the motor vehicle relates to a drive device of the motor vehicle, and the activation command predefines an operating strategy for the drive device.

19. A method for transmitting predictive information to a control unit of a motor vehicle and/or to a software module of the control unit to determine an activation command for at least one function of the motor vehicle, the method comprising:
forecasting a progression of a vehicle parameter of the motor vehicle for a predefined time interval;
determining at least one first extreme value of the forecasted progression within a first partial time interval of the predefined time interval starting at a present point in time;
determining at least one second extreme value of the forecasted progression within a second partial time interval of the predefined time interval starting at the present point in time, the second partial time interval being longer than the first partial time interval;
determining a reliability value for each of the determined extreme values, the reliability value describing a reliability of the forecasted progression in the respective partial time interval;
transmitting the determined at least one first extreme value, the determined at least one second extreme value, and the determined reliability values as the predictive information to the control unit and/or to the software module; and
utilizing the determined reliability values during the evaluation of the predictive information to determine the activation command for at least one function of the motor vehicle.

20. The method according to claim 19, wherein the reliability value is determined by comparing vehicle parameters forecasted for a past time interval to vehicle parameters measured during the past time interval, thereby assessing the accuracy of the forecasted progression.
